(19) United States
(12) Patent Application Publication
(10) Pub. No.: US 2021/0286839 A1
(43) Pub. Date: Sep. 16, 2021

(54) FILE SYNCHRONIZATION SYSTEM

(71) Applicant: David Sazan, Paramus, NJ (US)

(72) Inventor: David Sazan, Paramus, NJ (US)

(21) Appl. No.: 17/332,420

(22) Filed: May 27, 2021

Related U.S. Application Data
(63) Continuation of application No. 15/051,732, filed on Feb. 24, 2016, now abandoned.

(51) Int. Cl. G06F 16/438; G06F 16/9535; H04N 21/658; H04L 29/08; G06Q 20/12; H04N 21/482; H04N 21/258; G06F 16/638; H04N 21/262; G06Q 30/06; G06Q 20/14

(52) U.S. Cl. CPC G06F 16/4387; H04N 21/472; H04N 21/6582; H04L 67/26; G06Q 20/127; H04N 21/4828; H04N 21/25808; G06F 16/639; G06Q 20/123; H04L 67/125; H04N 21/26258; G06Q 30/0623; G06Q 30/0631; G06Q 30/06; G06Q 20/145; H04L 67/02; H04L 67/10; G06F 16/9535

(57) ABSTRACT

A database system for facilitating partial synchronization of a user file list with a confidential file list and eliminating duplicative file transfer. A database stores the confidential file list; and an intermediary server receives a notice after a first computing device is used to access a file not already listed in the confidential file list and to display the file to a user of the first computing device, updating the confidential file list to include the file. In response to receiving a request for a specific number of files less than an entirety of the confidential file list to be provided from the confidential file list, the server identifies a set of files present only in the confidential file list and not in a user file list, and causes transmission of only those files, thereby ensuring that network resources are not wasted and the confidential file list is not disclosed.

### CROSS-REFERENCE TO RELATED APPLICATION

This application is a continuation of and claims benefit to co-pending U.S. patent application Ser. No. 15/051,732, filed Feb. 24, 2016, which is hereby incorporated by reference in its entirety.

### FIELD OF INVENTION

This disclosure relates generally to protection of confidential data, and more particularly, to allowing files (e.g., digitized content) from a list of confidential files to be disclosed to a data consumer without compromising the confidentiality of the list of files as a whole.

### BACKGROUND

There are many instances in which digital files stored in a centralized database need to be accessed by a particular individual without disclosure to the individual of the entire listing of files stored in that centralized database.

For example, because celebrities are often trendsetters who people want to emulate, people may be extremely interested in what media celebrities consume and what connections that they have to others. While a music playlist can be shared with others, and many celebrities have posted playlists online, these are static play lists and are often artificially populated and not reflective of what they are really listening to. However, once a celebrity posts the playlist online, the celebrity loses control over the playlist because people can distribute the listing elsewhere. Celebrities need a way to share listings of files (i.e., digital content) based upon on non-static, real-time use, without losing control of the information because the entire list is no longer confidential.

### BRIEF SUMMARY OF INVENTION

A database system for facilitating partial synchronization of a user file list with a confidential tile list and eliminating duplicative file transfer is disclosed. A database stores the confidential file list; and an intermediary server receives a notice after a first computing device is used to access a file not already listed in the confidential file list and to display the file to a user of the first computing device, updating the confidential file list to include the file. In response to receiving a later request for a specific number of files less than an entirety of the confidential file list to be provided from the confidential file list, as well as a user file list of already accessible files, the server identifies which tiles are present only in the confidential file list and not in the user file list, and which files are present in both. Finally, the server causes transmission of only files that are not in the user file list, ensuring that no network resources are wasted transmitting a file that would be a duplicate of a file on the second computing device and ensuring that a user of the second computing device is unable to determine every file listed in the confidential file list.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a block diagram of an illustrative computing device that may be utilized to implement the various features and processes described herein;

FIG. 2 illustrates, in simplified form, an exemplary system in which a cloud-based computing environment acts as a content comparator;

FIG. 3 illustrates, in simplified form, an alternative exemplary system in which the cloud-based computing environment acts as a content comparator/exchanger;

FIG. 4 illustrates an example comparison between content in a celebrity playlist and a user's existing content;

FIG. 5 illustrates, in simplified form, the results of the comparison in the example of FIG. 4;

FIG, (i illustrates, in simplified form, an exemplary process flow; and

FIG. 7 illustrates a representative example of a cloud computing node of a cloud computing environment.

### DETAILED DESCRIPTION

A technical solution has been devised to address the problem of how a celebrity can allow a user to access the contents of the celebrity's digital media playlist without the user being able to view that playlist. The systems and associated computer-implemented methods involve creating a celebrity content listing (“playlisst”), and importantly, keeping that content listing non-viewable (“blinded”) from the user, comparing the user's existing digital media content to the digital media content in the celebrity content listing to identify missing content that the user does not have access to (“missing content”), and, optionally for a fee paid by the user, allowing the user to purchase, rent or legally download missing content to the user's computing device.

The technical solution may be implemented as a cloud-based solution that obtains one or more celebrity content listings (playlists) stored on one or more computing devices associated with one or more celebrities. Such celebrity content listings may include (but are not limited to) music listened to, videos watched, TV channels/shows watched, web sites visited, blogs read, social media content followed, pictures viewed, places visited, items purchased, and applications (apps) used, which are just a few of the many examples of listings of content that can typically be acquired from a celebrity's computing device.

Representative examples of digital media content include (but are not limited to) owned, licensed, and rented digital music files, music albums, playlists, compilations, movies, television shows, eBooks, audiobooks, newspapers, magazines, web browsing, bookmarks, user preference data, audio podcasts, video podcasts, software applications apps), documents, etc.

Users who want to have matching digital media content to celebrity of interest submit a request (preferably with an associated payment of a fee) over a network using the user's computing device, which request is received by the cloud-based computing environment. The cloud-based computing environment compares the user's existing digital media content to the digital media content on the celebrity's playlist to identify what content is missing from the user's existing content (“missing content”), and provides some or all of the missing content (or a pathway for accessing the content, e.g., a link to a YouTube video) to the user's device, either through the cloud-based service acting as an intermediary, or directly from one or more content providers to the user's one or more computing devices.

Although this disclosure is described in connection with a cloud computing environment, it is understood that implementation of the teachings recited herein are not limited to a cloud computing environment. Rather, embodiments of the present disclosure are capable of being implemented in conjunction with any other type of computing environment now known or later developed.

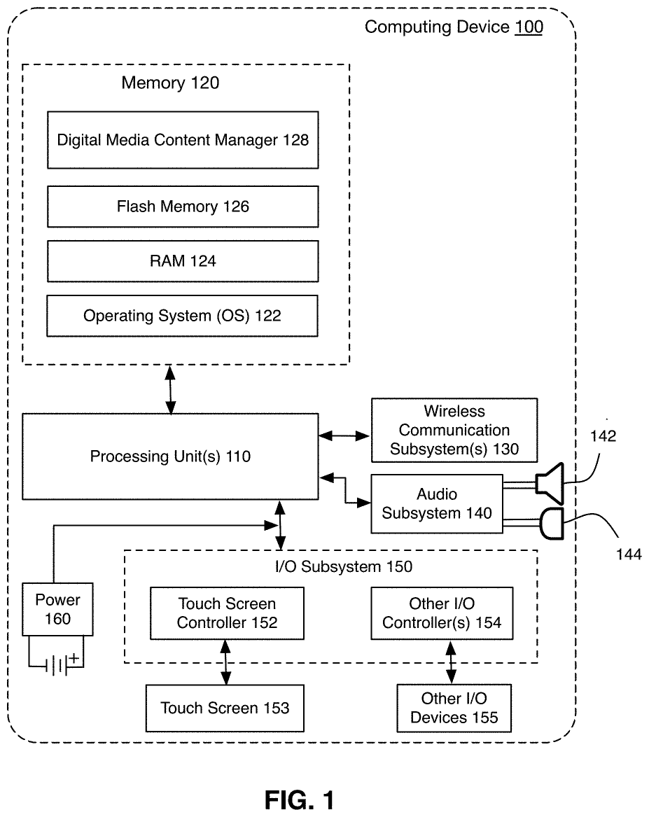

FIG. 1 is a block diagram of an illustrative computing device 100 for use in connection with various embodiments of this disclosure. Examples of computing devices 100 include (but are not limited to) mobile phones, smartphones, digital music players, tablets, digital video players, laptop computers, personal computers, personal digital assistants (PDAs), servers, virtual machines, online cloud storage locations, and other computing products configured to store or playback digital media content.

As shown, the computing device 100 includes one or more processing units 110 coupled to system memory 120, and various sensors and subsystems including (but not limited to) wireless communication subsystem(s) 130, audio subsystem 140, 110 subsystem 150, power subsystem 160, etc.

The processing unit(s) 110 is coupled to system memory 120, which stores various software components or applications to be executed by processing unlit's) 110. Preferably, memory 120 stores an operating system (OS) 122, which includes various procedures, sets of instructions, software components and/or drivers for controlling and managing general system tasks (e.g., memory management, storage device control, power management, etc.) and facilitates communication between various hardware and software components. System memory 120 also preferably includes RAM 124 and non-volatile flash memory 126, a combination of volatile/non-volatile memory, and/or any other type of memory.

System memory 120 also includes a digital media content manager 128, which is an application (e.g., iTunes®, Windows® Media Player, Real Rhapsody®, etc.) for creating, sharing, search, organizing and accessing playlists of digital media content stored on (or otherwise accessible to) the device 100.

System memory 120 may also include communication instructions to facilitate communicating with one or more additional devices; graphical user interface (GUI) instructions to facilitate GUI processing; image processing instructions to facilitate image-related processing and functions; input processing instructions to facilitate input-related (e.g., touch input) processes and functions; audio processing instructions to facilitate audio-related processes and functions; camera instructions to facilitate camera-related processes and functions; and biometric verification instructions to facilitate the verification of biometric data. It is understood that the communication instructions described above are merely exemplary and the system memory 120 may also include: additional instructions. For example, memory 120 for a computing device 110 may include phone instructions to facilitate phone-related processes and functions. It is also understood that the above-mentioned instructions need not be implemented as separate software programs or modules.

Wireless communication subsystem 130 facilitates communication functions over a network. For example, Wireless communication subsystem 130 may include one or more transmitters and receivers (not shown), which are implemented to operate over a network, which may be a wide area network (WAN) such as the Internet, the Public Switched Telephone Network (PSTN), a local area network (LAN), an intranet, an extranet, a cellular network, any wired or wireless network, or any combination of the above.

Audio subsystem 140 is coupled to speaker(s) 142 to output audio and to microphone 144 to facilitate voice-enabled functions, such as voice recognition, digital recording, etc.

I/O subsystem 150 facilitates the transfer between I/O peripheral devices, such as (hut not limited to) a touch screen 153, and the data bus of the processing unit(s) 110. I/O subsystem 150 includes a touch screen controller 152 and other I/O controller(s) 154 to facilitate the transfer between 110 peripheral devices 153, 155 and the data bus of processing unit(s) 100.

The computing device 100 also includes one or more power source(s) 160 for powering the various hardware components of the computing device. Power source 160 may include a power management system, one or more power sources, a recharging system, a power failure detection circuit, a power converter or inverter, a power status indicator, and any other components typically associated with the generation, management and distribution of power in computing devices.

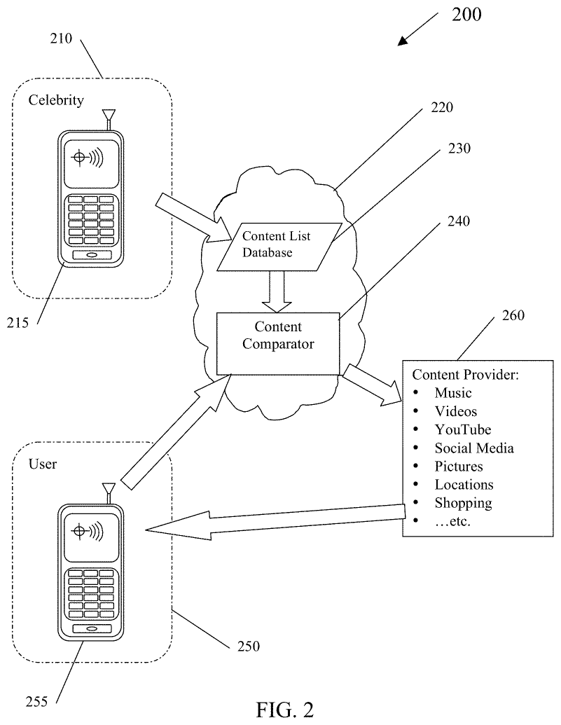

FIG. 2 illustrates, in simplified form, an exemplary system 200 in which the cloud based service 220 acts as a content comparator 240. One or more celebrities 210 utilize one or more computing device(s) 215 to interact wirelessly over a network with a computer programmed cloud-based service 220, which obtains, from the celebrity's computing device 215, a celebrity content listing that is stored in one or more content list databases 230.

In addition to the content list database(s) 230, the cloud-based service 220 also includes one or more computer programmed content comparators 240. The content comparator(s) 240 is responsible for receiving a request from a computing device 255 of a user 250 for content related to a specific celebrity 210, accessing information about the user's existing content stored on (or otherwise accessible by) the user's one or more computing device(s) 255, comparing the user's existing content to the celebrity content list stored in the content list database(s) 230, and determining what content, if any, is missing (“missing content”) from the user's existing content.

Once the missing content has been determined (and the user has preferably paid for it), the cloud-based service 220 works cooperatively with one or more content providers 260 to provide the missing content to the user's computing device(s) 255.

The computing devices 215, 255 illustrated in FIG. 2 may be implemented using the illustrative computing device 100 of FIG. 1 or any other known computing device configured to store or playback digital media content.

With respect to the cloud-based service 220 obtaining the celebrity content listing from the celebrity's computing device(s) 215, this can be performed by either the celebrity's computing device(s) 215 pushing the celebrity content listing to the cloud-based service 220 or the celebrity content listing being pulled from the celebrity's computing device(s) 215. Pushing can he accomplished in a conventional manner and typically would employ an app that either runs in the foreground or background of the celebrity's computing device(s) 215. The app would be configured to determine the celebrity content listing from information stored on (or otherwise accessible to) the celebrity's computing device(s) 215 and to send the information to the cloud-based service 220. Pulling can similarly be accomplished in a conventional manner and may employ an app running in the foreground or background of the celebrity's computing device(s) 215 that the cloud-based service 220 interacts with, or the cloud-based service 220 may acquire the celebrity content listing by directly accessing information stored on (or otherwise accessible to) the celebrity's computing device(s) 215, without the use of an app, such as when the celebrity's computing device(s) 215 is plugged into a docking station.

Whether pulling or pushing is utilized, the celebrity content listing is preferably periodically updated, which can similarly be through either pulling or pushing, but need not be performed in the same manner as the celebrity content listing was originally obtained. Updates can either be performed in real time (e.g., if the celebrity content listing is associated with musical content listened to, then every time a song is listened to by the celebrity 210 that content listing could be automatically updated), based on the passage of time (e.g., hourly, nightly, weekly, monthly, etc.), based on an event (e.g., new musical content is acquired by the celebrity 210), and/or initiated by the celebrity 210 (e.g., the celebrity pressed an update button within an app running on the celebrity's computing device 215).

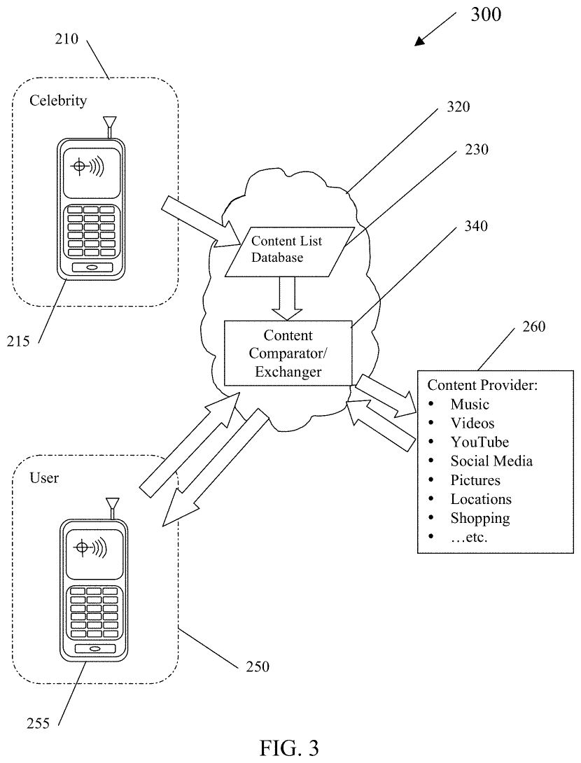

While FIG. 2 illustrates missing content being provided directly from the content provider(s) 260 to the user's computing device(s) 255, it is understood that the missing content could alternatively be provided with a cloud-based service acting as an intermediary, which is illustrated in FIG. 3. FIG, 3 illustrates, in simplified form, an exemplary system 300 in which the cloud-based service 320 acts as a content comparator/exchanger 340. (00361 The representative systems 200, 300 disclosed in FIGS. 2 and 3 are similar in structure and operation, except that in FIG. 3 the content is first received by the content comparator/exchanger 340 from the content provider 260 prior to being provided to the user's computing device(s) 255.

While the content comparator/exchanger 340 is shown as a single component in FIG. 3, it is understood that the content comparator/exchanger could alternatively be divided into separate components, where one component handles the comparing and the other component handles the exchanging.

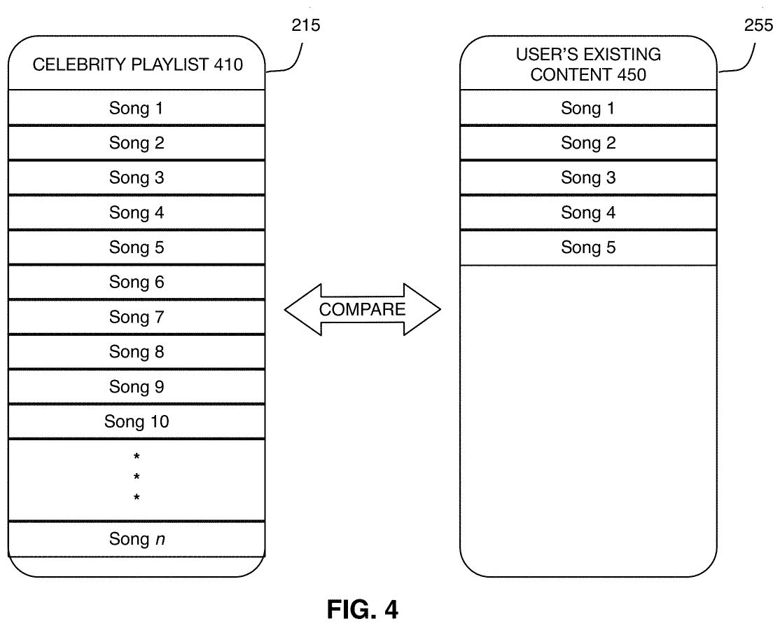

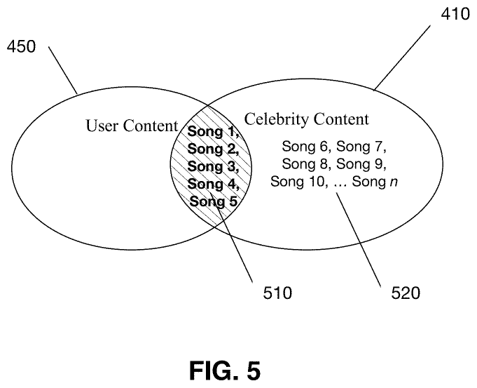

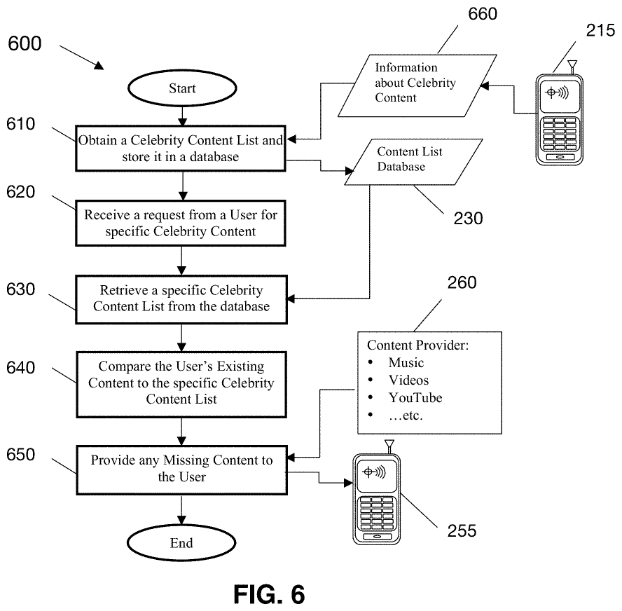

FIGS. 4 and 5 illustrate, in simplified form, an example in which the comparator 240, 340 identifies missing content from a user's computing device 255 upon receipt of a celebrity content request from the user 250. In this example, a celebrity content listing 410 created by a celebrity 210 lists digital media content in the form of a playlist. In this example, the celebrity playlist 410 includes Song 1, Song 2, Song 3, Song 4, Song 5, Song 6, Song 7, Song 8, Song 9, Song 10, . . . Song n). The comparator 240, 340 compares the celebrity playlist 410 to the user's existing content 450 stored on (or otherwise accessible by) computing device(s) 255 associated with the user 250. In this example, the user's existing content includes Song 1, Song 2, Song 3, Song 4 and Song 5.

Referring to FIG. 5, based on comparison of the celebrity playlist 410 to the user's existing content 450, the comparator 240, 340 identifies missing content 520, which represents the portion of the celebrity playlist 410 that the is not contained within the user's existing content 450. In this example, the area of overlap 510 represents the digital media content (i.e., Song 1, Song 2, Song 3, Song 4 and Song 5) identified in the celebrity playlist 410 that is part of the user's existing content 450. Similarly, in this example, the comparator 240, 340 would identify the missing content as Song 6, Song 7, Song 8, Song 9, Song 10, . . . Song n.

By only providing missing content to the user, the full contents of the celebrity's content list 410 are not provided to the user. While it is conceivable for a user to start without any user content 100 and ultimately discover the total celebrity content 410 by purchasing all of the missing content 510, this would require the user to purchase all of the celebrity content 410, at perhaps considerable expense to the user and a financial gain to the celebrity. Additionally, by periodically updating the celebrity content 410, then, in order for the user 250 to obtain a complete and accurate list of the celebrity content 410, the user would have to each and every time start without any user content 100 in order to obtain the complete updated celebrity content list. The reason being that, while a second purchase might provide any “new” missing content, the user would not be privy to, or have knowledge of, any content that was no longer a part of the celebrity content 410 because the deleted content would still be a part of the user's content acquired during the initial purchase. Furthermore, while it is advantageous to employ both only providing missing content and periodically updating the content together, both strategies can also be deployed separately to aid a celebrity in maintaining control over disclosure of the celebrity's content listings.

Having described exemplary systems above, exemplary methods will now be described. To this end, FIG. 6 illustrates, in simplified form, an exemplary process flow 600, which includes the following steps using one or more computer programmed processors. In Step 610, a celebrity content list is obtained and stored in database 230. As previously described, obtaining a celebrity content list and storing it in database 230 may involve either pushing or pulling information about celebrity content 660 stored in one or more of the celebrity's computing devices 215, which may be an actual device in the possession of the celebrity 210 or a server based account (e.g., iTunes that is associated with the celebrity 210. Once obtained, the celebrity content list is stored in one or more content list databases 230.

In Step 620, a request is received over a network from the computing device 255 of a user 250 for specific celebrity content, By way of example only, the request from the user 250 may be related to a particular Celebrity (e.g., Taylor Swift, Tom flanks, Tom Brady, President Obama, etc.), category/group of celebrities e.g., heavy metal guitarists, members of the band Kiss®, etc.), a type of content (music, videos, social media, etc.), a sub-categorization of content (e.g., Jazz songs within the celebrity's content of music), frequency of access by the celebrity, most recent access by the celebrity, related to the user himself (e.g., only music where there is a matching genre between the user and the celebrity or that is age appropriate for the user), or have a quantity associated with specificity (e.g., all missing, a specific quantity of missing, a percentage missing, a quantity missing that has a cost of acquisition by the user related to a specific dollar amount, etc.). Additionally, receipt of a request for specific celebrity content may be accompanied by an associated payment by the user, in order for the missing digital media content (missing content) to be provided to the user's device 255.

In Step 630, responsive to the request received from the user 250, a specific celebrity content list is retrieved from databases) 230. In Step 640, the user's existing content is compared to the specific celebrity content list retrieved from database 230. This comparison, performed by the content comparator 240, 340, may be performed either before or after the user 250 has made the specific request for content. If the comparison is performed before, the request is made, than such information may be supplied to the user's computing device 255 for display to the user 250 ahead of time (e.g., Elton John's music playlist includes 12 songs that are not in the user's playlist related to show tunes). Alternatively, the user 250 can make the request without knowing the quantity of missing content, and preferably commit an associated payment, and then receive a refund (inclusive of a partial order processing) if the user paid for more requested content than is available as missing content. The latter approach is advantageous because it provides more control over the celebrity content listing because less information is publicly disclosed.

In Step 650, missing content is provided to the user's computing device 255 via one or more networks. As previously discussed in connection with FIGS. 2 and 3, missing content may be provided to the user 250 by either downloading the missing content to the user's computing device(s) 255 directly from the content provider 260 (FIG. 2) or indirectly via the content comparator/exchanger 340 (FIG. 3).

Additionally, when the quantity of missing content exceeds the quantity of requested content, the missing content may be provided to the user (Step 650) based upon predetermined criteria, which may include (but is not limited to) one of more of the following criteria: random selection, frequency of access by the celebrity, most recent access by the celebrity, and/or secondary categorization (e.g., based upon properties of the of the existing content of the user such as, for example, a high concentration of Beatles® songs).

The exemplary systems and methods discussed above are equally applicable to any type of celebrity content including (but not limited to) music listened to, videos watched, TV channels/shows watched, web sites visited, blogs read, social media content followed, pictures viewed, places visited, items purchased, and apps used, which are just a few of the many examples of listings of content that can typically be acquired from celebrity computing device(s) 100, 215.

As stated above, although not limited to cloud computing environments, some embodiments of this disclosure are described as being implemented in a cloud computing environment. A cloud computing environment is service oriented with a focus on statelessness, low coupling, modularity, and semantic interoperability. At the heart of cloud computing is an infrastructure comprising a network of interconnected nodes.

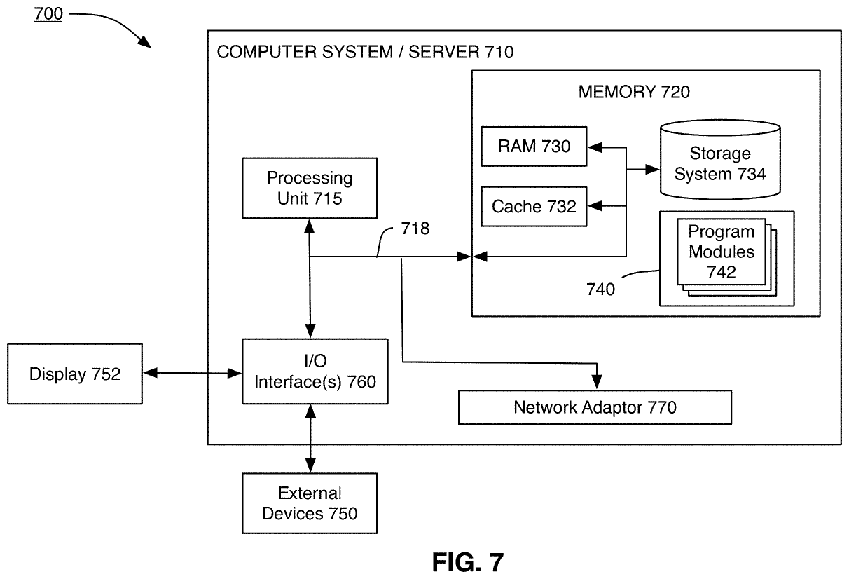

Referring to FIG. 7, a schematic of an example of a cloud computing node is shown. Cloud computing node 700 is only one example of a suitable cloud computing node and is not intended to suggest any limitation as to the scope of use or functionality of embodiments of the invention described herein. Regardless, cloud computing node 700 is capable of being implemented and/or performing any of the functionality set forth hereinabove.

In cloud computing node 700, there is a computer system/server 710, which is operational with numerous other general purpose or special purpose computing system environments or configurations. Examples of well-known computing systems, environments, and/or configurations that may be suitable for use with computer system/server 710 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 710 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 710 may be practiced in distributed cloud computing environments where tasks are performed by remote processing devices that are linked through a communications network. In a distributed cloud computing environment, program modules may be located in Both local and remote computer system storage media including memory storage devices.

As shown in FIG. 7, computer system/server 710 in cloud computing node 700 is shown in the form of a general-purpose computing device. The components of computer system/server 710 may include, but are not limited to, one or more processors or processing units 715, a system memory 720, and a bus 718 that couples various system components including system memory 720 to processing unit(s) 715.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 710 typically includes a variety of computer system readable media. Such media may be any available media that is accessible by computer system/server 710, and it includes both volatile and non-volatile media, removable and non-removable media.

System memory 720 can include computer system readable media in the form of volatile memory, such as random access memory (RAM) 730 and/or cache memory 732. Computer system/server 710 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can he connected to bus 718 by one or more data media interfaces. As will be further depicted and described below, memory 720 may include at least one program product having a set (e.g., at least one) of program modules that are configured to carry out the functions of embodiments of the invention.

Program/utility 740, having a set (at least one) of program modules 742, may be stored in memory 720 by way of example, and not limitation, as well as an operating system, one or more application programs, other program modules, and program, data. Each of the operating system, one or more application programs, other program modules, and program data or some combination thereof, may include an implementation of a networking environment. Program modules 742 generally carry out the functions and/or methodologies of embodiments of the invention as described herein.

Computer system/server 710 may also communicate with one or more external devices 750 such as a keyboard, a pointing device, a display 752, etc.; one or more devices that enable a user to interact with computer system/server 710; and/or any devices (e.g., network card, modem, etc.) that enable computer system/server 710 to communicate with one or more other computing devices. Such communication can occur via Input/Output (I/O) interfaces 760. Still yet, computer system/server 710 can communicate with one or more networks such as a local area network (LAN), a general wide area network (WAN), and/or a public network (e.g., the Internet) via network adapter 770. As depicted, network adapter 770 communicates with the other components of computer system/server 710 via bus 718. It should be understood that although not shown, other hardware and/or software components could be used in conjunction with computer system/server 710. Examples, include, but are not limited to: microcode, device drivers, redundant processing units, external disk drive arrays, RAID systems, tape drives, and data archival storage systems, etc.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can he downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), In sonic embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing, apparatus, or other device to cause a series of operational steps to be performed on the computer, other programmable apparatus or other device to produce a computer implemented process, such that the instructions which execute on the computer, other programmable apparatus, or other device implement the functions/acts specified m the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A database system for facilitating partial synchronization of a user file list with a confidential file list and eliminating duplicative file transfer, comprising:
a database storing the confidential file list; and
an intermediary server comprising at least one processor and non-transient memory that stores program instructions which, when executed by the at least one processor, cause the at least one processor to:
receive a notice after a first computing device is used to access a file not already listed in the confidential file list and to display the file to a user of the first computing device;
in response to each notice, update the confidential file list to include the file;
receive a request transmitted from a second computing device for a specific number of files less than an entirety of the confidential file list to be provided from the confidential file list;
receive from the second computing device a user file list identifying existing files already accessible by the second computing device;
identify a first set of files, including at least one file, that are present in both the confidential file list and the user file list;
identify a second set of files present only in the confidential file list and not in the user file list; and
cause transmission of tip to the specific number of files only from the second set of files to the second computing device and preventing transmission of any files from the first set of files, thereby ensuring that no network resources are wasted transmitting a file that would be a duplicate of a file on the second computing device and ensuring that a user of the second computing device is unable to determine every file listed in the confidential file list.

2. The system of claim 1, wherein the database also stores secondary information related to each of the files of the confidential file list, and wherein the program instructions further cause the at least one processor to cause transmission of the secondary information related to each of the specific number of files only from the second set of files to the second computing device before causing transmission of the specific number of files only from the second set of files to the second computing device.

3. The system of claim 1, wherein the confidential file list is updated in real time when the first computing device is used to access a file not already listed in the confidential file list.

4. The system of claim 1, wherein the confidential file list is updated periodically upon the passage of a predetermined increment of time to include files not already listed in the confidential file list that were accessed by the first computing device.

5. The system of claim 1, wherein the confidential file list is updated in response to an action taken by a user of the first computing device.

6. The system of claim 1, wherein the specific number of files only from the second set of files are selected from among the second set of files based at least in part on frequency of access of the files via the first computing device.

7. The system of claim 1, wherein the specific number of files only from the second set of files are selected from among the second set of files based at least in part on recency of access via the first computing device.

8. The system of claim 1, wherein the specific number of files only from the second set of files are randomly selected from among the second set of files.

9. The system of claim 1, wherein the specific number of files only from the second set of files are selected from among the second set of tiles based at least in part on similar categorizations of the files to files in the user file list.

10. The system of claim 1, wherein a plurality of computing devices, including the first computing device, are used to access and display files, wherein a plurality of confidential file lists are stored in the database, each confidential file list corresponding to one computing device of the plurality of computing devices; wherein each of the plurality of confidential file lists are updated in response to the use of their corresponding computing device to access and display a file; wherein the intermediary server receives a request transmitted from the second computing device for the specific number of files to come from any of the plurality of confidential file lists; and wherein the transmission of the specific number of files does not indicate which of the confidential file lists had contained the specific number of files.

11. The system of claim 1, wherein, in response to one or more files being deleted from the confidential file list, the one or more files remain on the second computing device.

12. The system of claim 1, wherein the notice is a pull notification initiated by the intermediary server and wherein the first computing device includes software waiting to send the pull notification in response to receiving a message from the intermediary server.

13. The system of claim 1, wherein a particular application is provided to run on the first computing device and track files that are accessed and displayed, and to facilitate transmission of the notice to the intermediary server.

14. The system of claim 13, wherein a second particular application is provided to run on the second computing device and facilitate download of files identified by the intermediary server and selected to be among the specific number of files.
